(19) United States
(12) Patent Application Publication
(10) Pub. No.: US 2026/0268584 A1
(43) Pub. Date: Sep. 10, 2026

(54) RENDERING REPRESENTATIONS OF USERS ON A USER INTERFACE OF A VIRTUAL REALITY COMMUNICATION DEVICE

(71) Applicant: Telefonaktiebolaget LM Ericsson (publ), Stockholm (SE)

(72) Inventors: Pex Tufvesson, Lund (SE); Alexander Hunt, Tygelsjö (SE)

(21) Appl. No.: 18/874,324

(22) PCT Filed: Jun. 13, 2022
(86) PCT No.: PCT/EP2022/066043

§ 371 Date: Dec. 12, 2024

(51) Int. Cl. G06T 15/20; G06F 3/01

(52) U.S. Cl. CPC G06T 15/20; G06F 3/017; G06T 2200/24

(57) ABSTRACT

There is provided a method performed by a VR communication device to be used by a first user. A communication interface communicates information with a further VR communication device to be used by a further user. A representation of the further user is created and rendered based on the information communicated with the further VR communication device. An indication of a minimum distance to the representation of the further user is received from the first user. The minimum distance defines, for the first user, a closest perceived distance for the representation of the further user to be rendered at by the user interface. The representation of the further user is, based on the minimum distance received, rendered to, on the user interface, appear at the minimum distance received. The representation of the further user render is rendered based on a selection action of the first user.

### TECHNICAL FIELD

Embodiments presented herein relate to a virtual reality communication device, a system, a method, a computer program, and a computer program product for rendering representations of users on a user interface of the virtual reality communication device.

### BACKGROUND

In general terms, virtual reality (VR) is a simulated experience that can be similar to or completely different from the real world. Non-limiting examples of VR technologies can be found in entertainment applications (such as video games, and movies), in education applications (such as medical or military training, robot navigation, construction modelling, and airplane simulation) and business applications (such as virtual meetings or computer conferencing). VR can be combined with augmented reality technologies and mixed reality technologies, sometimes referred to as extended reality technologies.

VR systems commonly use either headsets or multi-projected environments to generate realistic images, sounds and other sensations that simulate a user's physical presence in a virtual environment defining the simulated experience. A user using a piece of VR equipment is able to look around in the simulated experience, move around in it, and interact with virtual features or items. The effect is commonly created by headsets comprising a head-mounted display with a small screen to be placed in front of the eyes of the user, but can also be created through specially designed rooms with multiple large screens. VR systems typically incorporates auditory and video feedback, but may also allow other types of sensory and force feedback through haptic technologies.

With avatar image-based VR, users can join the virtual environment in the form of a virtual representation of the user called an avatar. The users can then, by means of their avatar, interact with other users. The virtual environment might thus represent a virtual community, or a virtual world, or virtual space. The virtual environment might thus be populated by many users who can create a personal avatar, and simultaneously and independently explore the virtual world, participate in its activities and communicate with other users. However, in some situations, limitations in the physical space also impose, or imply, some limitations in the virtual environment.

### SUMMARY

An object of embodiments herein is to address the above issues.

According to a first aspect the object is addressed by providing VR communication device to be used by a first user. The VR communication device comprises a communication interface, a user interface, and a processing unit configured to control operations of the communication interface and the user interface.

The communication interface is configured to communicate information with a further VR communication device to be used by a further user. The processing unit is configured to create and render a representation of the further user based on the information communicated with the further VR communication device. The processing unit is configured to receive, from the first user, an indication of a minimum distance to the representation of the further user. The minimum distance defines, for the first user, a closest perceived distance for the representation of the further user to be rendered at by the user interface. The processing unit is configured to, based on the minimum distance received, render the representation of the further user to, on the user interface, appear at the minimum distance received.

According to a second aspect the object is addressed by providing a system. The system comprises a controller and a VR communication device to be used by a first user. The VR communication device comprises a communication interface, and a user interface. The controller is configured to control operations of the communication interface and the user interface. The communication interface is configured to communicate information with a further VR communication device to be used by a further user. The controller is configured to create and render a representation of the further user based on the information communicated with the further VR communication device. The controller is configured to receive, from the first user, an indication of a minimum distance to the representation of the further user. The minimum distance defines, for the first user, a closest perceived distance for the representation of the further user to be rendered at by the user interface. The controller is configured to, based on the minimum distance received, render the representation of the further user to, on the user interface, appear at the minimum distance received.

According to a third aspect the object is addressed by providing a method performed by a VR communication device to be used by a first user. The VR communication device comprises a communication interface, a user interface, and a processing unit configured to control operations of the communication interface and the user interface. The method comprises communicating, by the communication interface, information with a further VR communication device to be used by a further user. The method comprises creating and rendering, by the processing unit, a representation of the further user based on the information communicated with the further VR communication device. The method comprises receiving, by the processing unit and from the first user, an indication of a minimum distance to the representation of the further user. The minimum distance defines, for the first user, a closest perceived distance for the representation of the further user to be rendered at by the user interface. The method comprises rendering, by the processing unit and based on the minimum distance received, the representation of the further user to, on the user interface, appear at the minimum distance received.

According to a fourth aspect the object is addressed by providing a computer program. The computer program comprises computer program code which, when run on a VR communication device according to the first aspect, causes the VR communication device to perform a method according to the third aspect.

According to a fifth aspect the object is addressed by providing a computer program product comprising a computer program according to the fourth aspect and a computer readable storage medium on which the computer program is stored. The computer readable storage medium could be a non-transitory computer readable storage medium.

Advantageously, these aspects avoid unnecessary movements to be performed by users in virtual environments, thereby making the VR system in which any of these aspects is provided, user friendly.

Advantageously, these aspects enable representations, such as avatars, to be rendered in a virtual environment without clipping of polygons, which might otherwise occur when the representations come too close together in the virtual environment.

Advantageously, these aspects improve the user experience by easing the psychological strain of being too close to other users in a virtual environment.

In some embodiments, the processing unit is configured to, upon having created the representation of the further user, initially render the representation of the further user to appear at a pre-set distance on the user interface.

In some embodiments, the indication is received in the form of a selection action with respect to the representation of the further user.

In some embodiments, the selection action comprises a pulling gesture involving pulling the representation of the further user to appear to be closer than the pre-set distance when the minimum distance is shorter than the pre-set distance.

In some embodiments, the selection action comprises a pushing gesture involving pushing the representation of the further user to appear to be further away than the pre-set distance when the minimum distance is longer than the pre-set distance.

In some embodiments, the processing unit is configured to create and to render a new representation of the further user at the minimum distance and instruct the user interface to display the new representation of the further user, such that the representation of the further user appears to be moved from the pre-set distance to the minimum distance.

In some embodiments, the processing unit is configured to create and to render the movement of the representation of the further user according to a non-linear function.

In some embodiments, the non-linear function is dependent on whether the representation of the further user is moved to appear to be closer than the pre-set distance or is moved to appear to be further away than the pre-set distance.

In some embodiments, a respective minimum distance is set for each representation of further users rendered by the processing unit.

In some embodiments, the communication interface is configured to communicate information with a yet further VR communication device to be used by a yet further user; the processing unit is configured to create and render a representation of the yet further user based on the information communicated with the yet further VR communication device; and the processing unit is configured to receive, from the first user, an indication of a further minimum distance to the representation of the yet further user, where the further minimum distance defines, for the first user, a closest perceived distance for the representation of the yet further user to be rendered at by the processing unit, and where the further minimum distance is different from the minimum distance.

In some embodiments, the processing unit is configured to render the representation of the yet further user to, on the user interface, appear to be at the further minimum distance.

In some embodiments, representation of the further user is an avatar, such as a three-dimensional avatar. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

Moreover, the term “comprising” followed by statements of technical features or method steps should be understood as not excluding the presence of other technical features of method steps not stated in appended claims.

### BRIEF DESCRIPTION OF THE DRAWINGS

The inventive concept is now described, by way of example, with reference to the accompanying drawings, in which:

FIG. 1 schematically illustrates a VR communication device according to an embodiment

FIG. 2 is a schematic diagram illustrating a VR communication system according to an embodiment;

FIG. 3 and FIG. 6 are flowcharts of methods according to embodiments;

FIG. 4 schematically illustrates a user and a representation of another user according to embodiments;

FIG. 5 illustrate examples of non-linear functions according to embodiments;

FIG. 7 is a schematic diagram showing functional units of a controller according to an embodiment; and

FIG. 8 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

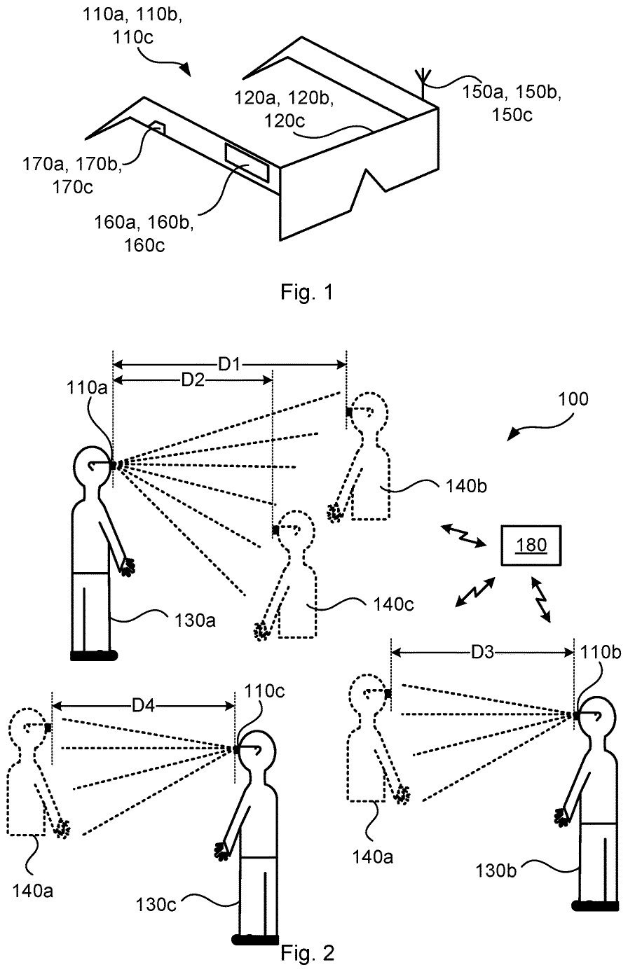

FIG. 1 is a schematic diagram illustrating a VR communication device 110a, 110b, 110c according to an embodiment. The VR communication device 110a, 110b, 110c is intended to be used by a user (see, FIG. 2). There could be different types of VR communication devices 110a, 110b, 110c. FIG. 1 schematically illustrates an example where the VR communication devices 110a, 110b, 110c are provided as a head-mountable display taking the shape of a pair of glasses. The VR communication device 110a, 110b, 110c comprises a user interface 120a, 120b, 120c for displaying a representation of other users as well as for displaying other information in a virtual environment. In some examples, the user interface 120a, 120b, 120c may comprise two small high-resolution monitors adapted to provide separate images for each eye for stereoscopic graphics rendering a 3D virtual environment, a binaural audio system, positional and rotational real-time head tracking for six degrees of movement. The VR communication device 110a, 110b, 110c may be provided with motion controls (not shown) with haptic feedback for physically interacting within the virtual world in an intuitive way. In particular, the VR communication device 110a, 110b, 110c further comprises a communication interface 150a, 150b, 150c for communicating with another VR communication device 110a, 110b, 110c and/or with a controller (see, FIG. 2). Although illustrated as an antenna, for example suitable for any type of radio communications (cellular was well as non-cellular), the communication interface 150a, 150b, 150c might be a wired communication interface, an infrared communication interface, a visible light communication interface, or some other kind of communication interface. In this respect, the VR communication device 110a, 110b, 110c might be configured for direct communication with each other or for communicating with each other via at least one other device, such as a mobile phone, personal computer, gaming machine, a server, a cloud computational system, or the like. The VR communication device 110a, 110b, 110c further comprises a processing unit 160a, 160b, 160c for controlling operation of the VR communication device 110a, 110b, 110c. With intermediate reference to FIG. 2, although the controller 180 is illustrated as a separate device in FIG. 2, the controller 180 might equally be implemented partly or fully by the processing unit 160a, 160b, 160c in at least one VR communication device 110a, 110b, 110c. In the example of FIG. 1, the VR communication device 110a, 110b, 110c further comprises a speaker and/or microphone 170a, 170b, 170c or other type of audio playing or recording device. Audio recorded at one VR communication device 110a, 110b, 110c can be transferred to be played out at another VR communication device 110a, 110b, 110c via the communication interface 150a, 150b, 150c. In general terms, each VR communication device 110a, 110b, 110c is configured to track movements made by its user, or equally, as made by the avatar of the user in the virtual space. Then the processing unit 160a, 160b, 160c of the VR communication device 110a, 110b, 110c renders the position of the user, or, equally, of the avatar. This information is also, via the communication interface 150a, 150b, 150c, provided to other VR communication devices 110a, 110b, 110c, either directly, or via a network to which all VR communication device 110a, 110b, 110c are operatively connected. The processing unit 160a, 160b, 160c further keeps track of the position of other users, or equally, of other avatars in the virtual space. In order to do so, information is communicated to the processing unit 160a, 160b, 160c via the communication interface 150a, 150b, 150c, for example from the network. Upon having received the information of the movements of the other users, or equally, of their avatars, the processing unit 160a, 160b, 160c performs the corresponding rendering.

FIG. 2 is a schematic diagram illustrating a VR communication system 100 where embodiments presented herein can be applied. The VR communication system 100 comprises three VR communication devices 110a, 110b, 110c and a controller 180. Each VR communication device 110a, 110b, 110c is used by a respective user 130a, 130b, 130c. As schematically illustrated by bi-directional arrows, the controller 180 is configured to communicate with the VR communication devices 110a, 110b, 110c. The controller 180 might for this purpose be operatively connected to, or be part of, a wireless, or wired, communication system, where the controller 180 is configured to orchestrate, and act as a hub for, the communication between the VR communication devices 110a, 110b, 110c. For this purpose, the functionality of the controller 180 might be provided in a modem, or an access node, such as a radio access network node.

For notation purposes and without imposing any hierarchical relationship among the VR communication devices 110a, 110b, 110c, VR communication device 110a is hereinafter denoted a first VR communication device 110a, whereas VR communication device 110b is hereinafter denoted a second VR communication device 110b, and VR communication device 110c is hereinafter denoted a third VR communication device 110c. The first VR communication device 110a comprises a first user interface 120a for displaying a representation 140b of user 130b and user 130c. The second VR communication device 110b comprises a second user interface 120b for displaying a representation 140a of user 130a.

The third VR communication device 110c comprises a third user interface 120c for displaying a representation 140a of user 130a. There could be different representations 140a, 140b, 140c. In some examples, each representation 140a, 140b, 140c is an avatar, such as a three-dimensional (3D) avatar. Further, as is appreciated by the skilled person, the VR communication system 100 might comprise a plurality of VR communication devices, each having its own user interface, and each being configured for communication with the other VR communication devices, either directly or via the controller 180.

It is here emphasized that the schematic diagram in FIG. 2 only represents one illustrative example of an environment in which the herein disclosed embodiments could be applied.

As noted above, limitations in the physical space also impose, or imply, some limitations in the virtual environment.

Further in this respect, even though the virtual environment might be unlimited, the physical space in which the users 130a, 130b, 130c are located when using the VR communication devices 110a, 110b, 110c, is limited. This limits the type of movement and/or the amount of movement the users 130a, 130b, 130c are enabled to make. For example, when any of the representations 140b, 140c appears to be too close, the first user 130a might have limited possibility to, due to limitations in the physical space, move backwards so as to increase this distance. In FIG. 2 the minimum distances at which each respective user 130a, 130b, 130c would like the representation 140a, 140b, 140c of another user 130a, 130b, 130c to appear are represented by distances D1, D2, D3, and D4. It is here noted that all these distances might be equal to each other or different from each other or a combination of both. If the first user 130a needs to further increase the distance this might, in some situations, require the first user 130a to leave the virtual environment. This is one example of where limitations in the physical space also impose, or imply, some limitations in the virtual environment. It is an object of embodiments presented herein to overcome such limitations. It is a further object of embodiments presented herein to make the virtual environment more similar to the real world with respect to the communication between different avatars, or other types of representations 140a, 140b, 140c of the users 130a, 130b, 130c, in the virtual environment.

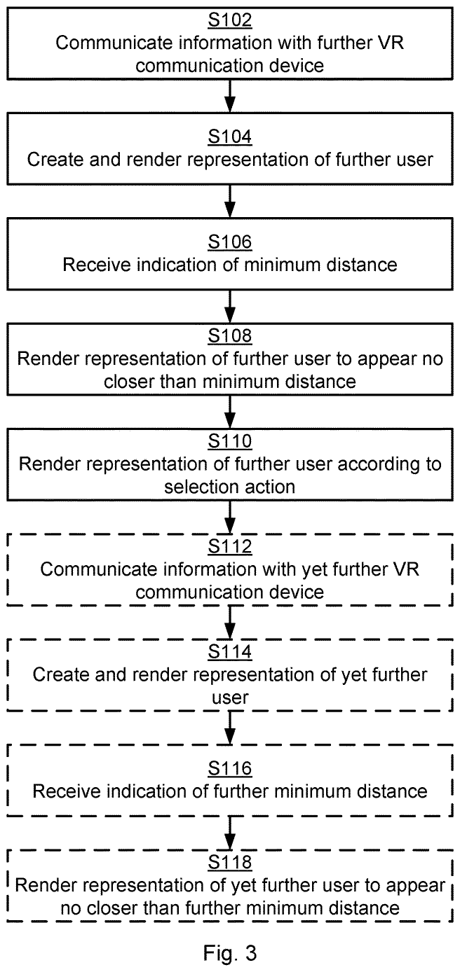

FIG. 3 is a flowchart illustrating embodiments of methods. The methods are advantageously provided as one or more computer programs. The methods are performed by the VR communication device 110a. It is here noted that in some embodiments, the controller 180 takes the role of the processing unit 160a and thus steps S104, S106, and S108 (as well as optional steps S114, S116, S118) are performed by the controller 180 and not by the processing unit 160a, etc. Hence, any reference to the processing unit 160a in the following could be replaced by a reference to the controller 180.

As disclosed above, the VR communication device 110a is to be used by a first user 130a and comprises a communication interface 150a, a user interface 120a, and a processing unit 160a, where the processing unit 160a is configured to control operations of the communication interface 150a and the user interface 120a.

S102: The communication interface 150a communicates information with a further VR communication device 110b. The further VR communication device 110b is to be used by a further user 130b.

S104: The processing unit 160a creates and renders a representation 140b of the further user 130b based on the information communicated with the further VR communication device 110b.

S106: The processing unit 160a receives, from the first user 130a, an indication of a minimum distance DI to the representation 140b of the further user 130b. The minimum distance D1 defines, for the first user 130a, a closest perceived distance for the representation 140b of the further user 130b to be rendered at by the user interface 120a.

S108: The processing unit 160a, based on the minimum distance DI received, renders the representation of the further user 130b to, on the user interface 120a, appear at the minimum distance DI received.

S110: The processing unit 160a, based on a selection action of the first user 130a, renders the representation 140b of the further user 140b. The selection action comprises moving the representation of the further user 130b nearer or further away from the first user 130a depending on the distance of the representation 140b of the further user 130b to the minimum distance DI.

Embodiments relating to further details of the method as performed by the VR communication device 110a will now be disclosed.

In some aspects, before the representation of the further user 130b is rendered to, on the user interface 120a, appear at the minimum distance received, the representation 140b of the further user 130b to appear at a pre-set distance on the user interface 120b. That is, in some embodiments, the processing unit 160a is configured to in step S104, upon having created the representation 140b of the further user 130b, initially render the representation 140b of the further user 130b to appear at a pre-set distance on the user interface 120a.

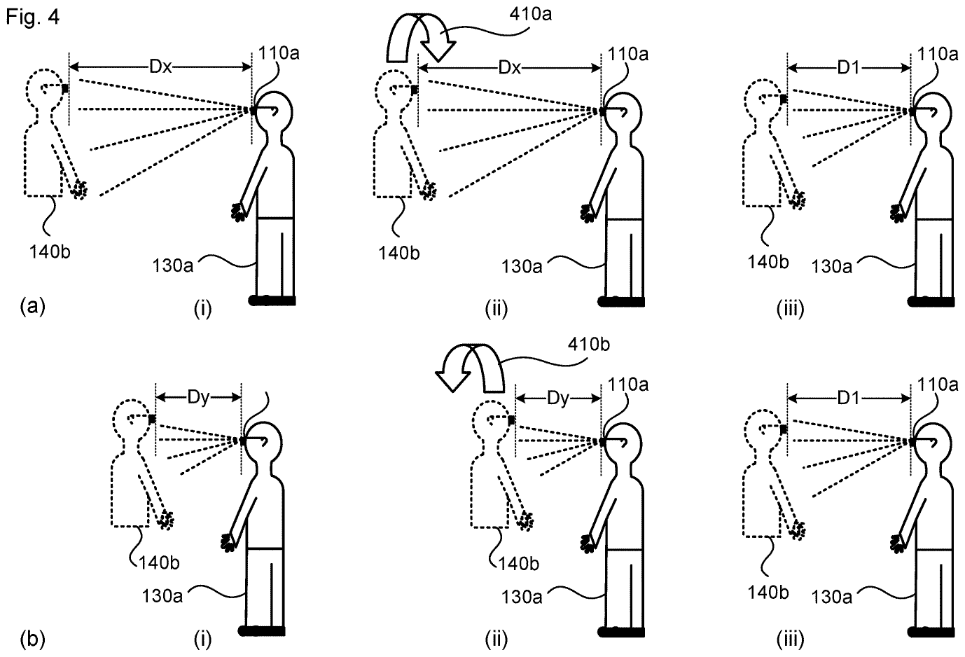

In some examples, the selection action is a point-and-select action. Intermediate reference is here made to FIG. 4.

FIG. 4(a)(i) schematically illustrates that the representation 140b of the further user initially is rendered to, on the user interface of the first VR communication device 110a as used by the first user 130a, appear at pre-set distance Dx. It is here assumed that distance Dx is larger than the minimum distance D1. FIG. 4(a)(ii) schematically illustrates that a selection action 410a is received that indicates that the representation 140b of the further user is to be rendered to appear to be closer to the first user 130a. This selection action 410a could therefore be regarded as a pulling gesture, or other type of hand movement, moving the representation of the further user 130b nearer the first user 130a. That is, in some examples, the selection action 410a comprises a pulling gesture, or other type of hand movement, involving pulling the representation 140b of the further user 130b to appear to be closer than the pre-set distance when the minimum distance DI is shorter than the pre-set distance. FIG. 4(a)(iii) schematically illustrates that the representation 140b of the further user, as a result of the selection action 410a, is rendered to appear at the minimum distance D1 to the first user 130a. Using a pulling gesture, or other type of hand movement, the first user 130a can thus control the optimal collaboration distance, as given by the minimum distance DI, by selecting another user 13ba, grabbing the representation 140b of the further user 130b and move the representation 140b closer to reduce the distance to the representation 140b in accordance with the minimum distance D1. In this way the personal zone of the first user 130a can be reduced without this being noticed by the further user 130b. Also, the new distance to the further user 130b is not communicated to the further user 130a and thus the further user 130b would be unaware of any change in distance.

FIG. 4(b)(i) schematically illustrates that the representation 140b of the further user 130b initially is rendered to, on the user interface of the first VR communication device 110a as used by the first user 130a, appear at pre-set distance Dy. It is here assumed that distance Dy is smaller than the minimum distance D1. FIG. 4(b)(ii) schematically illustrates that a selection action 410b is received that indicates that the representation 140b of the further user is to be rendered to appear to be further away from the first user 130a. This selection action 410b could therefore be regarded as a pushing gesture, or other type of hand movement, moving the representation of the further user 130b further away from the first user 130a. That is, in some examples, the selection action 410b comprises a pushing gesture, or other type of hand movement, involving pushing the representation 140b of the further user 130b to appear to be further away than the pre-set distance when the minimum distance DI is longer than the pre-set distance. FIG. 4(b)(iii) schematically illustrates that the representation 140b of the further user, as a result of the selection action 410b, is rendered to appear at the minimum distance D1 to the first user 130a.

Using a pushing gesture, or other type of hand movement, the first user 130a can thus control the optimal collaboration distance, as given by the minimum distance D1, by selecting another user 130b, grabbing the representation 140b of the further user 130b and move the representation 140b further away to increase the distance to the representation 140b in accordance with the minimum distance D1. In this way the personal zone of the first user 130a can be expanded without this being noticed by the further user 130b.

With respect to FIG. 4(a)(iii) and FIG. 4(b)(iii) the processing unit 160a might therefore be configured to create and to render a new representation of the further user 130b at the minimum distance D1 and instruct the user interface 120a to display the new representation of the further user 130b, such that the representation 140b of the further user 130b appears to be gradually moved from the pre-set distance (Dx or Dy) to the minimum distance D1. In this respect, when the first user 130a has performed a selection action, or similar, it is only the rendering of the representation of the further user 130b that is updated, or moved, such that the representation of the further user 130b is rendered to, on the user interface 120a, appear at the minimum distance D1.

It is here noted that there could be other types of selection actions in addition to, or in contrast to, pulling gestures and pushing gestures, or other types of hand movements. For example, the user 130a might select the minimum distance DI in a menu, for example as accessible via the user interface 120a.

There could be different ways in which the representation 140b of the further user 130b is gradually moved from the pre-set distance (Dx or Dy) to the minimum distance D1. In some aspects, the coordinates according to which the representation 140b of the further user 130b is rendered are warped depending on the distance at which the representation of the further user 130b is rendered to appear on the user interface 120a.

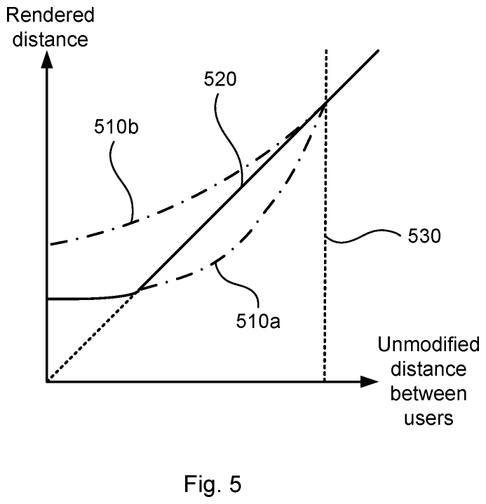

Intermediate reference is here made to FIG. 5. Two non-linear functions 510a, 510b represent examples of how to render different distances depending on if the first user 130a has performed a selection action comprising a pulling gesture (non-linear function 510a) or a selection action comprising a pushing gesture (non-linear function 510b). A reference linear function is illustrated at 520 and a threshold distance for activating any of the non-linear functions 510a, 510b is shown at 530. The representation 140b will be moved according to the non-linear functions 510a, 510b in accordance with the received selection. The representation 140b of the further user 130b will thus be shown at a non-linearly changing distance depending on at which distance the representation 140b is rendered to appear. In some embodiments, the processing unit 160a is therefore configured to create and to render a gradual movement of the representation 140b of the further user 130b according to a non-linear function 510a, 510b. As illustrated in FIG. 5, the non-linear function 510a, 510b is dependent on whether the representation 140b of the further user 130b is moved to appear to be closer than the pre-set distance or is moved to appear to be further away than the pre-set distance.

There could be different types of non-linear functions 510a, 510b. In this respect. The X meter threshold defines a limit where the non-linear functions 510a, 510b continue as linear functions (as the distance increases). In some non-limiting illustrative examples, X is in the order of 2 meters. In further examples, the non-linear function 510a is initially linear, then is convex and then becomes linear again at the X meter threshold.

It is here emphasized that the movement of the distance at which the representation 140b of the further user 130b is to appear on the user interface 120a does not impact how, or at what distance, the representation 140a of the first user 130a is rendered to appear on the user interface 120b. Hence, even though the minimum distance DI is smaller or larger than the minimum distance at which the representation of the first user 130a is rendered to, on the user interface 120b, appear, moving the representation 140b of the further user 130b in this way does not impact the distance at which the representation of the first user 130a is rendered to, on the user interface 120b, appear. With reference to FIG. 1 this implies that the distance DI not necessarily is equal to the distance D3 (or D4).

In some aspects, the minimum distance at which representation of further users 130b, 130c are to appear on the user interface 120a, is set differently for the further users 130b, 130c. That is, in some embodiments, a respective minimum distance D1, D2 is set for each representation 140b, 140c of further users 130b, 130c rendered by the processing unit 160a. In this way, a respective value of the minimum distance can be set for each of the further users 130b, 130c.

Continued reference is now made to FIG. 4. In some embodiments, the method further comprises steps S112-S116.

S112: The communication interface 150a communicates information with a yet further VR communication device 110c. the yet further VR communication device 110c is to be used by a yet further user 130c.

S114: The processing unit 160a creates and renders a representation 140c of the yet further user 130c based on the information communicated with the yet further VR communication device 110c.

S116: The processing unit 160a receives, from the first user 130a, an indication of a further minimum distance D2 to the representation 140c of the yet further user 130c.

The further minimum distance D2 defines, for the first user 130a, a closest perceived distance for the representation 140c of the yet further user 130c to be rendered at by the processing unit 160a. The further minimum distance D2 is different from the minimum distance D1.

In some embodiments, the method further comprises step S118.

S118: The processing unit 160a renders the representation 140c of the yet further user 130c to, on the user interface 120a, appear to be at the further minimum distance D2.

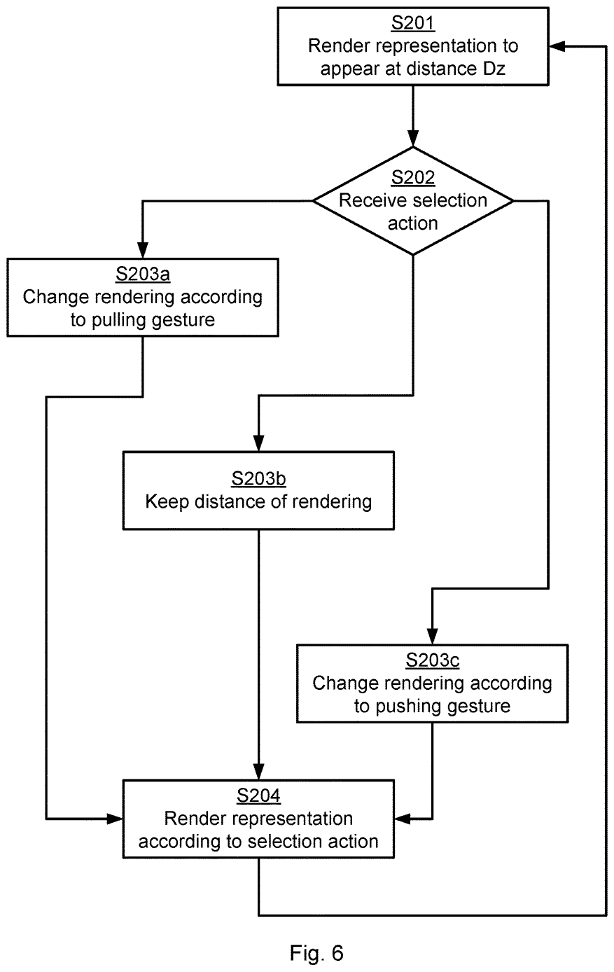

Reference is next made to the flowchart of FIG. 6 disclosing a method according to at least some of the herein disclosed embodiments.

S201: The processing unit 160a renders a representation 140b of the further user 130b to, on the user interface 120a of the VR communication device 110a used by the first user 130a, appear to be at current distance Dz.

S202: The processing unit 160a receives selection action from the first user 130a. depending on the type of selection action, one of steps S203a, S203b, or S203c is entered.

S203a: The selection action comprises a pulling gesture involving pulling the representation 140b of the further user 130b to appear to be closer than the current distance Dz.

S203b: The selection action neither comprises a pulling gesture nor comprises a pushing gesture.

S203c: The selection action comprises a pushing gesture involving pushing the representation 140b of the further user 130b to appear to be further away than the current distance Dz.

S204: The processing unit 160a renders the representation 140b of the further user 130b to appear at a distance defined according to the type of selection action received.

Step S201 can then be entered again with the value of Dz updated in according to the distance defined according to the type of selection action received.

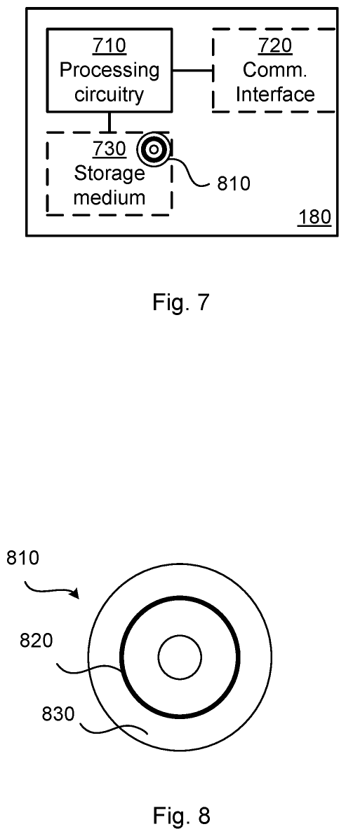

FIG. 7 schematically illustrates, in terms of a number of functional units, the components of a controller 180 according to an embodiment. Processing circuitry 710 is provided using any combination of one or more of a suitable central processing unit (CPU), multiprocessor, microcontroller, digital signal processor (DSP), etc., capable of executing software instructions stored in a computer program product 810 (as in FIG. 8), e.g. in the form of a storage medium 730. The processing circuitry 710 may further be provided as at least one application specific integrated circuit (ASIC), or field programmable gate array (FPGA).

Particularly, the processing circuitry 710 is configured to cause the controller 180 to perform a set of operations, or steps, as disclosed above. For example, the storage medium 730 may store the set of operations, and the processing circuitry 710 may be configured to retrieve the set of operations from the storage medium 730 to cause the controller 180 to perform the set of operations. The set of operations may be provided as a set of executable instructions.

Thus the processing circuitry 710 is thereby arranged to execute methods as herein disclosed. The storage medium 730 may also comprise persistent storage, which, for example, can be any single one or combination of magnetic memory, optical memory, solid state memory or even remotely located memory. The controller 180 may further comprise a communications interface 720 at least configured for communications with other entities, functions, nodes, and devices, such as the VR communication devices 110a, 110b, 110c. As such the communications interface 720 may comprise one or more transmitters and receivers, comprising analogue and digital components. The processing circuitry 710 controls the general operation of the controller 180 e.g. by sending data and control signals to the communications interface 720 and the storage medium 730, by receiving data and reports from the communications interface 720, and by retrieving data and instructions from the storage medium 730.

Other components, as well as the related functionality, of the controller 180 are omitted in order not to obscure the concepts presented herein.

The controller 180 may be provided as a standalone device or as a part of at least one further device. For example, the controller 180 may be provided in one of the VR communication devices 110a, 110b, 110c. Thus, a first portion of the instructions performed by the controller 180 may be executed in a first device, and a second portion of the of the instructions performed by the controller 180 may be executed in a second device; the herein disclosed embodiments are not limited to any particular number of devices on which the instructions performed by the controller 180 may be executed. Hence, the methods according to the herein disclosed embodiments are suitable to be performed by a controller 180 residing in a cloud computational environment. Therefore, although a single processing circuitry 710 is illustrated in FIG. 7 the processing circuitry 710 may be distributed among a plurality of devices, or nodes. The same applies to the computer program 820 of FIG. 8.

FIG. 8 shows one example of a computer program product 810 comprising computer readable storage medium 830. On this computer readable storage medium 830, a computer program 820 can be stored, which computer program 820 can cause the processing circuitry 210 and thereto operatively coupled entities and devices, such as the communications interface 220 and the storage medium 230, to execute methods according to embodiments described herein. The computer program 820 and/or computer program product 810 may thus provide means for performing any steps as herein disclosed.

In the example of FIG. 8, the computer program product 810 is illustrated as an optical disc, such as a CD (compact disc) or a DVD (digital versatile disc) or a Blu-Ray disc. The computer program product 810 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 820 is here schematically shown as a track on the depicted optical disk, the computer program 820 can be stored in any way which is suitable for the computer program product 810.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A virtual reality, VR, communication device to be used by a first user comprising a communication interface a user interface and a processing unit configured to control operations of the communication interface and the user interface, wherein:
the communication interface is configured to communicate information with a further VR communication device to be used by a further user;
the processing unit is configured to create and render a representation of the further user based on the information communicated with the further VR communication device;
the processing unit is configured to receive, from the first user, an indication of a minimum distance (D1) to the representation of the further user, wherein the minimum distance (D1) defines, for the first user, a closest perceived distance for the representation of the further user to be rendered at by the user interface;
the processing unit is configured to, based on the minimum distance (D1) received, render the representation of the further user to, on the user interface appear at the minimum distance (D1) received.

2. The VR communication device according to claim 1, wherein, the processing unit is configured to, upon having created the representation of the further user, initially render the representation of the further user to appear at a pre-set distance on the user interface.

3. The VR communication device according to claim 1, wherein the indication is received in form of a selection action with respect to the representation of the further user.

4. The VR communication device according to claim 2, wherein the selection action comprises a pulling gesture involving pulling the representation of the further user to appear to be closer than the pre-set distance when the minimum distance (D1) is shorter than the pre-set distance.

5. The VR communication device according to claim 2, wherein the selection action comprises a pushing gesture involving pushing the representation of the further user to appear to be further away than the pre-set distance when the minimum distance (D1) is longer than the pre-set distance

6. The VR communication device according to claim 4, wherein the processing unit is configured to create and to render a new representation of the further user at the minimum distance and instruct the user interface to display the new representation of the further user, such that the representation of the further user appears to be moved from the pre-set distance to the minimum distance (D1).

7. The VR communication device according to claim 6, wherein the processing unit is configured to create and to render the movement of the representation of the further user according to a non-linear function.

8. The VR communication device according to claim 7, wherein the non-linear function is dependent on whether the representation of the further user is moved to appear to be closer than the pre-set distance or is moved to appear to be further away than the pre-set distance.

9. The VR communication device according to claim 1, wherein a respective minimum distance (D1, D2) is set for each representation of further users rendered by the processing unit.

10. The VR communication device according to claim 1, wherein:
the communication interface is configured to communicate information with a yet further VR communication device to be used by a yet further user;
the processing unit is configured to create and render a representation of the yet further user based on the information communicated with the yet further VR communication device; and
the processing unit is configured to receive, from the first user an indication of a further minimum distance (D2) to the representation of the yet further user,
wherein the further minimum distance (D2) defines, for the first user, a closest perceived distance for the representation of the yet further user to be rendered at by the processing unit, and wherein the further minimum distance (D2) is different from the minimum distance (D1).

11. The VR communication device according to claim 10, wherein:
the processing unit is configured to render the representation of the yet further user to, on the user interface, appear to be at the further minimum distance (D2).

12. The VR communication device according to claim 1, wherein the representation of the further user is an avatar, such as a three-dimensional avatar.

13. A system comprising a controller and a virtual reality, VR, communication device to be used by a first user, the VR communication device comprising a communication interface, and a user interface wherein the controller is configured to control operations of the communication interface and the user interface, wherein:
the communication interface is configured to communicate information with a further VR communication device to be used by a further user;
the controller is configured to create and render a representation of the further user based on the information communicated with the further VR communication device;
the controller is configured to receive, from the first user, an indication of a minimum distance (D1) to the representation of the further user, wherein the minimum distance (D1) defines, for the first user, a closest perceived distance for the representation of the further user to be rendered at by the user interface;
the controller is configured to, based on the minimum distance (D1) received, render the representation of the further user to, on the user interface, appear at the minimum distance received;

14. A method performed by a virtual reality, VR, communication device to be used by a first user, the VR communication device comprising a communication interface, a user interface, and a processing unit configured to control operations of the communication interface and the user interface, the method comprising:
communicating, by the communication interface information with a further VR communication device to be used by a further user;
creating and rendering, by the processing unit, a representation of the further user based on the information communicated with the further VR communication device;
receiving, by the processing unit and from the first user an indication of a minimum distance (D1) to the representation of the further user, wherein the minimum distance (D1) defines, for the first user, a closest perceived distance for the representation of the further user to be rendered at by the user interface;
rendering, by the processing unit and based on the minimum distance (D1) received, the representation of the further user to, on the user interface, appear at the minimum distance received.

15. A non-transitory computer-readable medium storing instructions executable by processing circuitry of a virtual reality, VR, communication device to be used by a first user, the VR communication device comprising a communication interface, a user interface, and a processing unit configured to control operations of the communication interface and the user interface, which when executed by the processing circuitry causes the VR communication device to:
communicate, by the communication interface, information with a further VR communication device to be used by a further user;
create and render, by the processing unit, a representation of the further user based on the information communicated with the further VR communication device;
receive, by the processing unit and from the first user, an indication of a minimum distance (D1) to the representation of the further user, wherein the minimum distance (D1) defines, for the first user, a closest perceived distance for the representation of the further user to be rendered at by the user interface; and
render, by the processing unit and based on the minimum distance (D1) received, the representation of the further user to, on the user interface, appear at the minimum distance received.

16. (canceled)
